(19) United States
(12) Patent Application Publication
(10) Pub. No.: US 2009/0301249 A1
(43) Pub. Date: Dec. 10, 2009

(54) Automobile Gear Shifter Kit

(76) Inventor: Timothy Smith, Foristell, MO (US)

Correspondence Address: JAY M. SCHLOFF, 6960 Orchard Lake Road, Suite 315, West Bloomfield, MI, 48322, US

(21) Appl. No.: 12/477,488

(22) Filed: Jun. 3, 2009

Related U.S. Application Data
(60) Provisional application No. 61/130,936, filed on Jun. 4, 2008.

(51) Int. Cl. F16H 59/04; B60K 20/00

(52) U.S. Cl. 74/473.12; 74/473.3

(57) ABSTRACT

An automobile gear shifter kit includes a handle member, a trigger member and an actuating mechanism. The handle member is capable of being removably coupled to a gear shifter shaft of an automobile. The handle member includes an inner surface and an outer surface. The inner surface is configured to define a cavity portion and the outer surface is configured to provide a pilot control grip. The trigger member is disposed on the outer surface and is capable of triggering actuation of at least one of shifting of gears of the automobile and an operation of pre-determined auxiliary function of the automobile. The actuating mechanism is disposed in the cavity portion and is operatively coupled to the trigger member for being triggered by the trigger member for actuating the at least one of the shifting of the gears of the automobile and the operation of pre-determined auxiliary function.

### CROSS-REFERENCE TO RELATED APPLICATIONS

The present disclosure claims priority under 35 United States Code, Section 119 on the U.S. Provisional Patent Application No. 61/130,936 filed on Jun. 4, 2008, the disclosure of which is incorporated by reference.

### FIELD OF THE DISCLOSURE

The present disclosure relates, in general, to automobile components, and more particularly to an automobile gear shifter kit for an automobile.

### BACKGROUND OF THE DISCLOSURE

Gear shifter arrangements typically include gear shifter shafts coupled to standard components of an automobile with a manual or an automatic transmission. A conventional gear shifter shaft includes a knob assembly for facilitating in gripping the conventional gear shifter shaft to enable an operator of the automobile to change gears of the automobile's transmission. However, conventional knob assemblies include various problems that preclude a proper gripping of the conventional gear shifter shaft. For example, structures and ergonomics of the conventional knob assemblies are such that the operator may feel inconvenience in the gripping thereof while maneuvering the conventional knob assemblies for changing the gears to provide transmission to the automobile.

Further, the automobile with the manual transmission, and the automobile with the automatic transmission, include several types of switches for performing auxiliary functions with regard to safety, controlling and lighting of the automobile. Generally, such switches are configured at various locations within the automobile. The operator of the automobile may need to operate such switches for performing auxiliary functions. While driving, the operator may be inconvenienced in locating a particular switch from the various locations of the automobile for a particular auxiliary function.

Accordingly, there exists a need to preclude inconvenience to an operator while changing gears for providing transmission to an automobile. Further, there exists a need to enable an operator to easily locate switches.

### SUMMARY OF THE DISCLOSURE

In view of the foregoing disadvantages inherent in the prior-art, the general purpose of the present disclosure is to provide an automobile gear shifter kit, to include all advantages of the prior art, and to overcome the drawbacks inherent in the prior art.

An object of the present disclosure to preclude inconvenience to an operator while changing gears for providing transmission to an automobile.

Another object of the present disclosure is to enable an operator to easily locate switches.

In light of the above objects, in an aspect of the present disclosure an automobile gear shifter kit is provided. The automobile gear shifter kit includes a handle member, a trigger member and an actuating mechanism. The handle member is capable of being removably coupled to a gear shifter shaft of an automobile. The handle member includes an inner surface and an outer surface. The inner surface is configured to define a cavity portion and the outer surface is configured to provide a pilot control grip for maneuvering the handle member. Further, the trigger member is disposed on the outer surface of the handle member. The trigger member is capable of triggering actuation of at least one of shifting of gears of the automobile and an operation of pre-determined auxiliary function of the automobile. Furthermore, the actuating mechanism is disposed in the cavity portion of the handle member. The actuating mechanism is operatively coupled to the trigger member and capable of being triggered by the trigger member for actuating the at least one of the shifting of the gears of the automobile and the operation of pre-determined auxiliary function.

According to another aspect of the present disclosure an automobile gear shifter kit for an automobile with an automatic transmission is provided. The automobile gear shifter kit includes a handle member, a trigger member and an actuating mechanism. The handle member is capable of being removably coupled to a gear shifter shaft of the automobile. The handle member includes an inner surface and an outer surface. The inner surface is configured to define a cavity portion and the outer surface is configured to provide a pilot control grip for maneuvering the handle member. The trigger member is disposed on the outer surface of the handle member. The trigger member is capable of triggering actuation of shifting of gears of the automobile with automatic transmission. The actuating mechanism included a trigger shaft, a hollow shaft and a shifter actuating shaft. The trigger shaft is operatively coupled to the trigger member and extending outwardly from the cavity portion of the handle member. Further, the hollow shaft is coupled to the handle member for removably coupling the handle member to the gear shifter shaft of the automobile with automatic transmission. The hollow shaft is capable of receiving the trigger shaft extending from the cavity portion of the handle member. The hollow shaft includes a slot configured thereon. Furthermore, the shifter actuating shaft is coupled to the trigger shaft via a clamp member passing through the slot. The shifter actuating shaft is capable of actuating the shifting of gears upon triggering of the trigger member.

According to another aspect of the present disclosure an automobile gear shifter kit for an automobile with an automatic transmission is provided. The automobile gear shifter kit includes a handle member, a trigger member and an actuating mechanism. The handle member is capable of being removably coupled to a gear shifter shaft of the automobile. The handle member includes an inner surface and an outer surface. The inner surface is configured to define a cavity portion and the outer surface is configured to provide a pilot control grip for maneuvering the handle member. The trigger member is disposed on the outer surface of the handle member. The trigger member is capable of triggering actuation of shifting of gears of the automobile with automatic transmission. The actuating mechanism includes a hollow guider, a rod and a pair of biasing arrangements. The hollow guider is disposed in the cavity portion of the handle member. Further, the rod is received within the hollow guider. Furthermore, the pair of biasing arrangements is capable of being triggered by the trigger member for actuating the rod to slide reciprocatingly within the hollow guider for actuating the shifting of gears.

According to another aspect of the present disclosure an automobile gear shifter kit an automobile with a manual transmission is provided. The automobile gear shifter kit includes a handle member, a trigger member and an actuating mechanism. The handle member is capable of being removably coupled to a gear shifter shaft of the automobile. The handle member includes an inner surface and an outer surface. The inner surface is configured to define a cavity portion and the outer surface is configured to provide a pilot control grip for maneuvering the handle member. The trigger member is disposed on the outer surface of the handle member. The trigger member is capable of triggering actuation of an operation of pre-determined auxiliary function of the automobile with manual transmission. The actuating mechanism includes an electrical conductive wire disposed within the cavity portion of the handle member removably coupled to the gear shifter shaft of the automobile with manual transmission for triggering actuation of the operation of pre-determined auxiliary function of the automobile with manual transmission.

The pilot control grip, of the automobile gear shifter kit, provided by the outer surface of the handle member facilitates an operator of an automobile to maneuver the handle member in a convenient manner, thereby precluding inconvenience to an operator while changing gears for providing transmission to the automobile. Further, the automobile gear shifter kit provides the trigger member operatively coupled to the actuating mechanism for facilitating the operator of the automobile for triggering actuation of the actuating mechanism for actuating the at least one of the shifting of the gears of the automobile and the operation of pre-determined auxiliary function, thereby enabling the operator to easily perform desired functions in the automobile.

These together with the other aspects of the present disclosure, along with the various features of novelty that characterized the present disclosure, are pointed out with particularity in the claims annexed hereto and form a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates a block diagram including an automobile gear shifter kit and a gear shifter shaft of an automobile, in accordance with an embodiment of the present disclosure;

FIG. 2A illustrates a side view of an automobile gear shifter kit for an automobile with automatic transmission, in accordance with an embodiment of the present disclosure;

FIG. 2B illustrates a front view of the automobile gear shifter kit of FIG. 2A, in accordance with an embodiment of the present disclosure;

FIG. 3 illustrates a side view of an exposed automobile gear shifter kit for depicting electrical wirings and an actuating mechanism of the automobile gear shifter kit, in accordance with an embodiment of the present disclosure;

FIG. 4 illustrates a side view of the actuating mechanism of FIG. 3, in accordance with an embodiment of the present disclosure;

FIG. 5 illustrates a side view of a portion of the automobile gear shifter kit mounted to a gear shifter shaft, in accordance with an embodiment of the present disclosure;

FIG. 6 illustrates a side view of an exposed automobile gear shifter kit for an automobile with automatic transmission, in accordance with another embodiment of the present disclosure;

FIG. 7A illustrates a side view of an exposed automobile gear shifter kit for an automobile with manual transmission, in accordance with another embodiment of the present disclosure; and

FIG. 7B illustrates a front view of an exposed automobile gear shifter kit of FIG. 7A, in accordance with another embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The term “first,” “second,” and the like, herein do not denote any order, elevation or importance, but rather are used to distinguish placement of one element over another. Further, the terms “a” and “an” herein do not denote a limitation of quantity, but rather denote the presence of at least one of the referenced item.

The present disclosure provides an automobile gear shifter kit for an automobile. The automobile gear shifter kit resembles a pilot's handle, such as that as is provided in fighter planes. The automobile gear shifter kit includes an ergonomic pistol grip casing with notches to accommodate human fingers comfortably. Further, the automobile gear shifter kit includes various electrical switches, and an adaptable trigger mechanism. The adaptable trigger mechanism actuates a gear shifting linkage in an automobile with an automatic transmission. Further, the various electrical switches are accessible to activate various auxiliary functions of the automobile with automatic transmission. Moreover, the present disclosure provides an automobile gear shifter kit for an automobile with a manual transmission. The automobile gear shifter kit for the automobile with manual transmission includes a pistol grip casing, various electrical switches and a trigger mechanism. The various electrical switches and the adaptable trigger mechanism are accessible to activate various auxiliary function of the automobile with manual transmission. The automobile gear shifter kit for the automobile with automatic transmission and for the automobile with manual transmission provides comfortable gripping to an operator, and enables the operator to use his/her fingers to operate the adaptable trigger mechanism for performing a specific function.

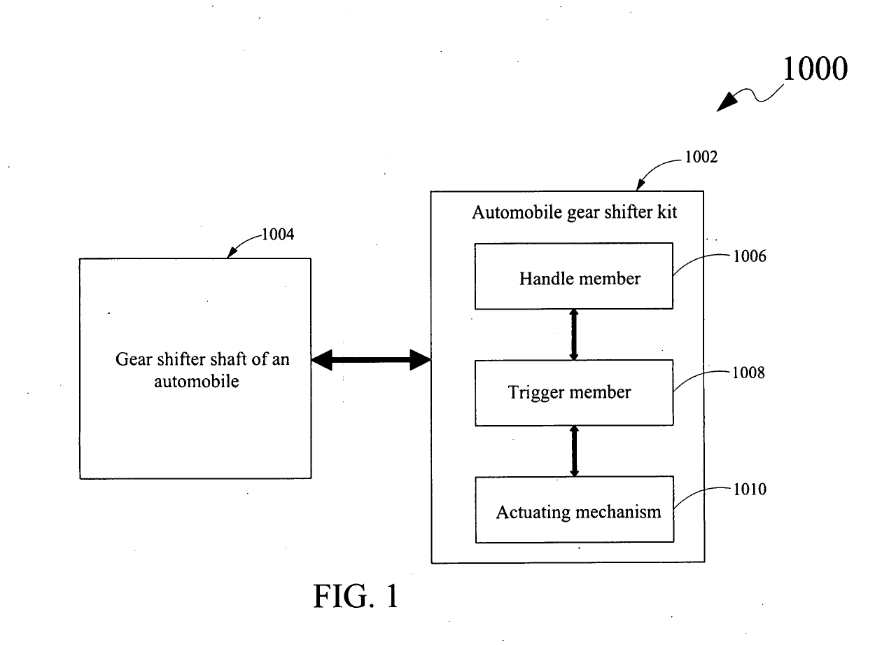

Referring to FIG. 1, a block diagram 1000 including an automobile gear shifter kit 1002 for a gear shifter shaft 1004 of an automobile (not shown) is illustrated, in accordance with an embodiment of the present disclosure. The automobile gear shifter kit 1002 includes a handle member 1006, a trigger member 1008 and an actuating mechanism 1010. More particularly, the handle member 1006 includes an inner surface (not shown) and an outer surface (not shown). Further, the inner surface of the handle member 1006 includes a cavity portion (not shown). The trigger member 1008 is disposed on the outer surface of the handle member 1006. Further, the actuating mechanism 1010 is disposed in the cavity portion of the inner surface of the handle member 1006. Furthermore, the actuating mechanism 1010 is operatively coupled to the trigger member 1008.

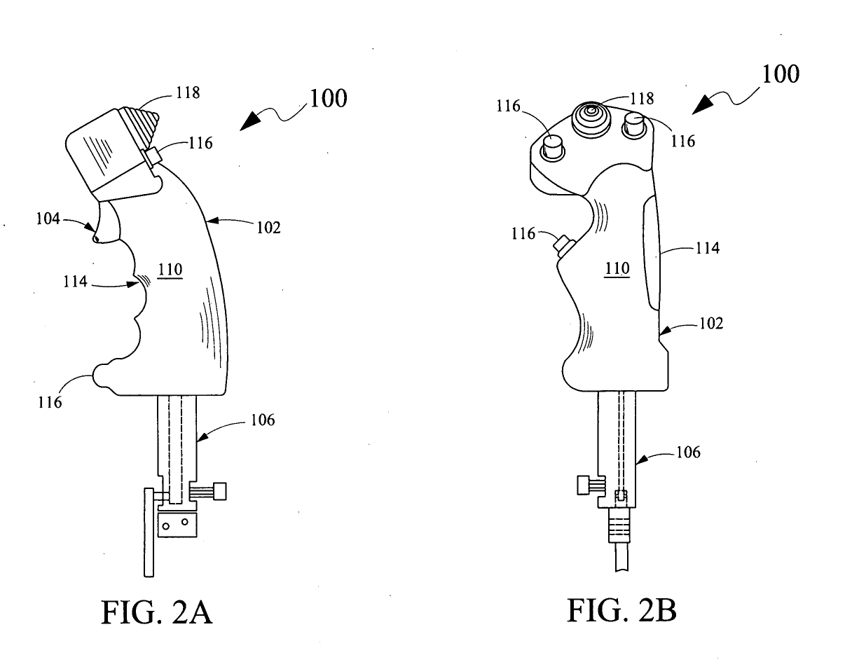

The handle member 1006 is capable of being removably coupled to the gear shifter shaft 1004 of the automobile. The trigger member 1008 disposed on the outer surface of the handle member 1006 is capable of triggering actuation of at least one of shifting of gears of the automobile and an operation of pre-determined auxiliary function of the automobile. Specifically, the actuating mechanism 1010 disposed in the cavity portion of the handle member 1006 is capable of being triggered by the trigger member 1008, disposed on the outer surface of the handle member 1006, for actuating the at least one of the shifting of gears of the automobile and the operation of pre-determined auxiliary function of the automobile. The handle member 1006 is configured in a manner such that an operator (not shown) of the automobile is capable of maneuvering the handle member 1006 in a convenient manner to perform the at least one of the shifting of gears of the automobile and the operation of pre-determined auxiliary function of the automobile. The various components, for example a handle member such as the handle member 1006, a trigger member such as the trigger member 1008 and an actuating mechanism such as the actuating mechanism 1010, of an automobile gear shifter kit such as the automobile gear shifter kit 1002 will be described in the form of various embodiments in conjunction with FIGS. 2A to 7B.

Referring now to FIG. 2A and FIG. 2B, an automobile gear shifter kit 100 for an automobile with automatic transmission (not shown, and herein after referred to as automatic transmission automobile) is illustrated. Particularly, FIG. 2A illustrates a side view of an automobile gear shifter kit 100 for the automatic transmission automobile, and FIG. 2B illustrates a front view of the automobile gear shifter kit 100 of FIG. 2A, in accordance with an embodiment of the present disclosure. The automobile gear shifter kit 100 includes a handle member 102, a trigger member 104, and an actuating mechanism 106. The handle member 102 is capable of being removably coupled to a gear shifter shaft (not shown) of the automatic transmission automobile. In an embodiment, the automobile gear shifter kit 100 may be configured to an after market gear shifter shaft of the automatic transmission automobile for shifting gears. The trigger member 104 and the actuating mechanism 106 are configured to the handle member 102 for triggering actuation of shifting of gears of the automatic transmission automobile. Specifically, the actuating mechanism 106 is capable of being triggered by the trigger member 104 for actuating the shifting of gears of the automatic transmission automobile. The handle member 102 is configured in a manner such that the operator of the automatic transmission automobile is capable of maneuvering the handle member 102 in a convenient manner to perform the shifting of gears of the automatic transmission automobile using the trigger member 104 and the actuating mechanism 106.

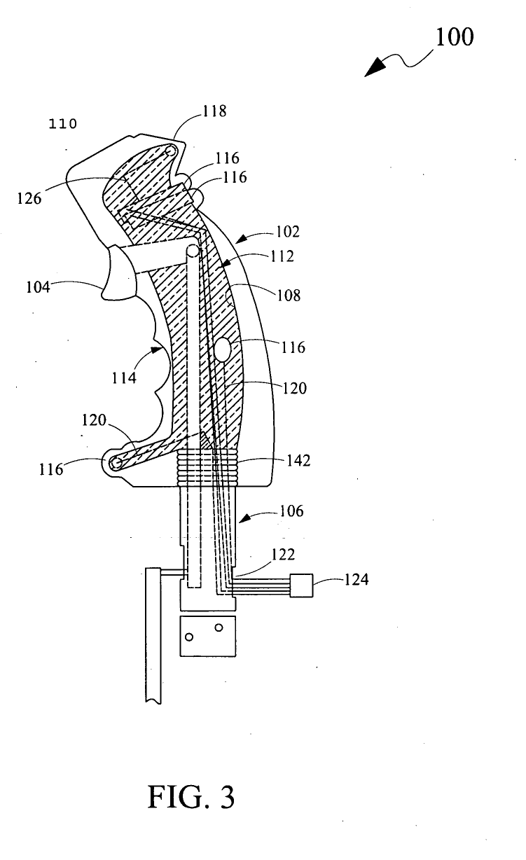

More specifically, the handle member 102 includes an inner surface 108 (shown in FIG. 3) and an outer surface 110. The inner surface 108 is configured to define a cavity portion 112 (shown as shaded region in FIG. 3). The trigger member 104 is disposed on the outer surface 110 of the handle member 102. The actuating mechanism 106 is disposed in the cavity portion 112 of the handle member 102. Further, the actuating mechanism 106 is operatively coupled to the trigger member 104 for actuating the shifting of gears of the automatic transmission automobile upon triggering the trigger member 104. Furthermore, the outer surface 110 is configured to provide a pilot control grip 114 for maneuvering the handle member 102 in a convenient manner to perform the shifting of gears of the automatic transmission automobile by the operator. Particularly, the outer surface 110 is configured to provide the pilot control grip 114 similar to flight control grips configured on pilot handle gear shifters of aircrafts. Further, the pilot control grip 114 enables the operator of the automatic transmission automobile to grip the handle member 102 in a similar manner as pistols are being gripped by using pistol grips.

According to one embodiment of the present disclosure, the handle member 102 is molded from a resin material. The handle member 102 molded from the resin material provides comfortable gripping to the operator. Without departing from the scope of the present disclosure, the handle member 102 may be molded or may be made from any other material know in the art. The handle member 102 molded from resin material with the pilot control grip 114 enhances adaptability of the automobile gear shifter kit 100 in terms of convenience and ergonomic gripping. The pistol control grip and the resin material composition of the handle member 102 enables the operator of the automatic transmission automobile to trigger the trigger member 104 disposed on the handle member 102 in comfortable manner.

The trigger member 104 is also molded along with the handle member 102 and is disposed on the outer surface 110 of the handle member 102. The trigger member 104 is capable of triggering actuation of shifting of gears of the automatic transmission automobile. Particularly, the trigger member 104 is operatively coupled to the actuating mechanism 106, and upon triggering the trigger member 104, the actuating mechanism 106 actuates the shifting of gears of the automatic transmission automobile. Further, in one embodiment of the present disclosure, the handle member 102 is removably coupled to the gear shifter shaft of the automatic transmission automobile via the actuating mechanism 106 for enabling the actuating mechanism 106 to actuate the shifting of gears of the automatic transmission automobile, upon triggering of the trigger member 104.

Moreover, the handle member 102 includes a plurality of switches, such as a switch 116 (herein after referred to as plurality of switches 116) and a joystick switch 118. The plurality of switches 116 and the joystick switch 118 are disposed on the outer surface 110 of the handle member 102. The plurality of switches 116 and the joystick switch 118 will be described in conjunction with FIG. 3.

Referring now to FIG. 3 a side view of an exposed automobile gear shifter kit, such as the automobile gear shifter kit 100 for depicting electrical wirings and the actuating mechanism 106 of the automobile gear shifter kit 100 is illustrated. Herein reference of FIGS. 2A and 2B will be taken to describe the plurality of switches 116 and the joystick switch 118. As shown, the plurality of switches 116 and the joystick switch 118 are disposed on the outer surface 110 of the handle member 102. Each switch of the plurality of switches 116 is configured with an electrical wire. The electrical wire of all the switches of the plurality of switches 116 is referred to as electrical wires 120. The electrical wires 120 pass through the cavity portion 112 of the handle member 102, and extend outwardly from the cavity portion 112 through a through hole 122 configured on a lower portion of the handle member 102. The electrical wires 120 are hosed using a wire harness 124. Further, the electrical wires 120 are coupled to the automatic transmission automobile's control panel (not shown) to perform a pre-determined auxiliary function of the automatic transmission automobile. Particularly, the each switch of the plurality of switches 116 is capable of being operated to perform the pre-determined auxiliary function of the automatic transmission automobile, such as a pre-determined auxiliary function of a trans-brake, a line-lock, a nitrous oxide activation, turning on a light, stopping flow of transmission fluid, and the like. Without departing from the scope of the present disclosure, the plurality of switches 116 is capable of actuation of any pre-determined auxiliary function of the automatic transmission automobile to which the plurality of switches 116 is rated for. Typically, voltage/current may flow through the electrical wires 120 when the plurality of switches 116 is pressed. Such voltage/current may flow through the electrical wires 120 to perform the pre-determined auxiliary function of the automatic transmission automobile. Further, such voltage/current may flow through the electrical wires 120 to perform the pre-determined auxiliary function of the automatic transmission automobile until the pressed plurality of switches, such as the plurality of switches 116 are released.

Furthermore, the joystick switch 118 disposed on the outer surface 110 of the handle member 102 is configured with an electrical wire 126. The electrical wire 126 is also hosed using the wire harness 124. The joystick switch 118 is capable of being operated to perform a plurality of pre-determined auxiliary functions of the automatic transmission automobile. More particularly, the joystick switch 118 is simply a multifunctional switch with several contact points instead of one contact point. Having the several contact points at one location may likely be more of a convenience to the operator of the automatic transmission automobile for performing the plurality of pre-determined auxiliary functions of the automatic transmission automobile. The plurality of pre-determined auxiliary functions performed by the joystick switch 118 may be similar to the pre-determined auxiliary function performed by the plurality of switches 116, such as a trans-brake, a line-lock, a nitrous oxide activation, turning on a light, stopping flow of transmission fluid, and the like. Further, in one embodiment of the present disclosure, the joystick switch 118 may preclude an electrical wire connection, such as the electrical wire 126 incapable of performing the plurality of pre-determined auxiliary functions of the automatic transmission automobile but rather just enhance style quotient of the handle member 102. Further, a joystick switch, such as the joystick switch 118 may provide a possible ergonomical benefit, such as a comfortable place to rest a thumb of the operator of the automatic transmission automobile, while maneuvering the handle member 102.

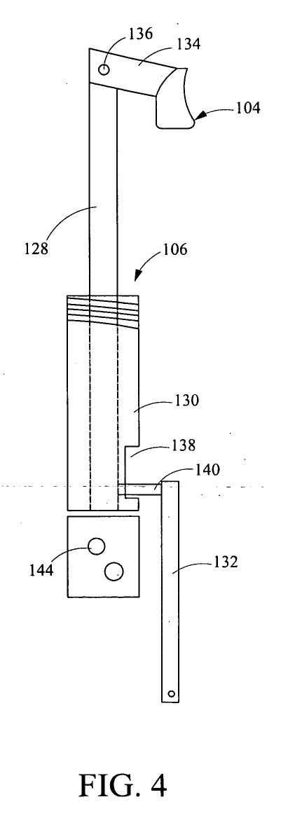

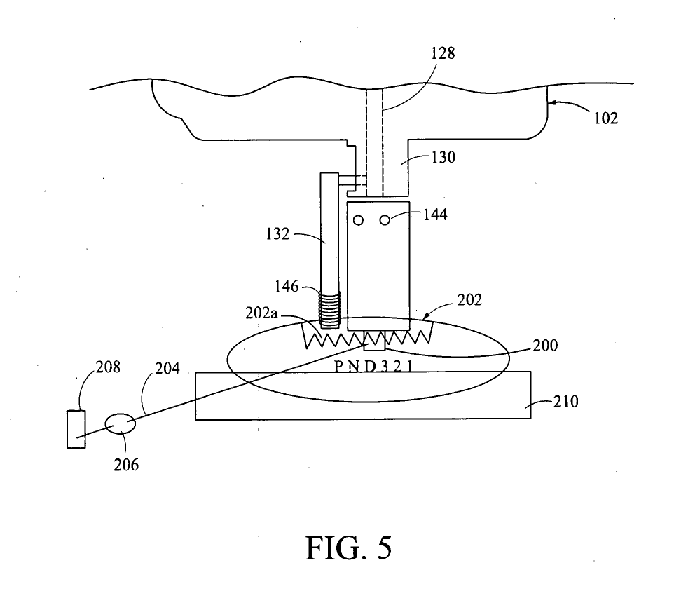

Referring to FIG. 4 a side view of the actuating mechanism 106 of FIG. 3 is illustrated, in accordance with an embodiment of the present disclosure. Herein reference of FIGS. 2A, 2B and 3 will be taken to describe the actuating mechanism 106 of the automobile gear shifter kit 100. The actuating mechanism 106 includes a trigger shaft 128, a hollow shaft 130, and a shifter actuating shaft 132. According to this embodiment, the handle member 102 may be removably coupled via the hollow shaft 130 to the gear shifter shaft of the automatic transmission automobile, and will be described in detail in conjunction with FIG. 5.

The trigger shaft 128 is operatively coupled to the trigger member 104 via a trigger lever 134, and extends outwardly from the cavity portion 112 of the handle member 102. Particularly, the trigger lever 134 extends from the trigger member 104 and is coupled to the trigger shaft 128 through a pivot pin 136 for configuring the operatively coupling between the trigger member 104 and the trigger shaft 128. Further, the hollow shaft 130 is capable of receiving the trigger shaft 128 extending from the cavity portion 112 of the handle member 102. The hollow shaft 130 includes a slot 138 configured thereon. The slot 138 receives a clamp member 140 passing therethrough. Particularly, the clamp member 140 is coupled to the trigger shaft 128 and passes through the slot 138. Furthermore, the shifter actuating shaft 132 is coupled to the trigger shaft 128 via the clamp member 140. The shifter actuating shaft 132 is capable of actuating the shifting of gears upon triggering of the trigger member 104.

As described above, in this embodiment, the handle member 102 is removably coupled to the gear shifter shaft of the automatic transmission automobile via the hollow shaft 130. More particularly, the handle member 102 is removably coupled to the hollow shaft 130 through a shaft bushing member 142 (shown in FIG. 3). Further, the hollow shaft 130 includes a pair of screw holes 144 for removably coupling the handle member 102 to the gear shifter shaft of the automatic transmission automobile. Coupling of the handle member and operating mechanism will be described in detail in conjunction with FIG. 5.

Referring now to FIG. 5, a side view of a portion of the automobile gear shifter kit 100 mounted to the gear shifter shaft, such as a gear shifter shaft 200 of the automatic transmission automobile is illustrated, in accordance with an embodiment of the present disclosure. Reference of FIGS. 2A to 4 will be made to describe FIG. 5. As shown in FIGS. 4 and 5, the hollow shaft 130 is removably coupled to the gear shifter shaft 200 of the automatic transmission automobile via the pair of screw holes 144 configured on the hollow shaft 130. Further, as shown in FIG. 5, on coupling the handle member 102 via the hollow shaft 130 to the gear shifter shaft 200, the shifter actuating shaft 132 passes from a side portion of the gear shifter shaft 200 to engage with a locking mechanism 202 of the automatic transmission automobile. Particularly, the gear shifter shaft 200 engages with the locking mechanism 202 of the automatic transmission automobile via a connector pin and spring assembly 146. Upon removably coupling the handle member 102 to the gear shifter shaft 200, the operator of the automatic transmission automobile may maneuver the handle member 102 to release the locking mechanism 202 for the shifting of gears of the automatic transmission automobile.

More particularly, when the trigger member 104 is depressed, the trigger lever 134, coupled to the trigger shaft 128 via the pivot pin 136, enables the trigger shaft 128 to move upward in the hollow shaft 130. Accordingly, the shifter actuating shaft 132, coupled to the trigger shaft 128 via the clamp member 140 passing through the slot 138 of the hollow shaft 130, moves upward and compresses the connector pin and spring assembly 146 to allow shifting of the gear shifter shaft 200 into locking grooves 202a of the locking mechanism 202 for enabling the operator of the automatic transmission automobile to select a desired gear from a neutral gear mode (N), a parking gear mode (P), and the like gear modes (D, 1, 2 and 3) available in the automatic transmission automobile. Further, when the trigger member 104 is released, the trigger shaft 128 comes to rest enabling the shifter actuating shaft 132 to sit in the locking grooves 202a of the locking mechanism 202, thereby locking the locking mechanism 202 of the automatic transmission automobile.

According to another embodiment of the present disclosure, the gear shifter shaft 200 may connect to a shifter cable 204 that passes through a through hole 206 configured on an automobile base (not shown) to couple with a shifter link 208 on a transmission system (not shown) of the automatic transmission automobile. Depending upon types of the automatic transmission automobile (whether or not an automatic transmission automobile includes a shifter plate 210), the shifter actuating shaft 132 releases and locks the locking mechanism 202 of the automatic transmission automobile for shifting of gears, by the help of the shifter cable 204 coupled to the shifter link 208.

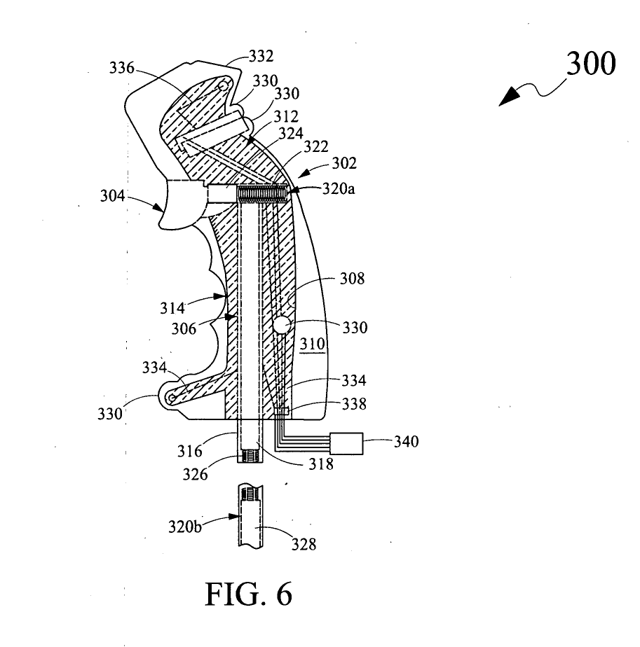

Referring now to FIG. 6 a side view of an exposed automobile gear shifter kit, such as an automobile gear shifter kit 300 for an automobile with automatic transmission (not shown, and hereinafter referred to as automatic transmission automobile) is illustrated, in accordance with another embodiment of the present disclosure. The automobile gear shifter kit 300 may be coupled to a gear shifter shaft, such as the gear shifter shaft 200 of the automatic transmission automobile explained in conjunction with FIG. 5. The automobile gear shifter kit 300 includes a handle member 302, a trigger member 304, and an actuating mechanism 306.

The handle member 302 is similar to the handle member 102 as described above. Further, similar to the handle member 102, the handle member 302 includes an inner surface 308 and an outer surface 310. The inner surface 308 is configured to define a cavity portion 312, (shown as shaded region). The outer surface 310 configured to provide a pilot control grip 314 similar to the pilot control grip 114. Herein the handle member 302 has not been described in detail for the sake of the brevity. The trigger member 304, similar to the trigger member 104, is disposed on the outer surface 310 of the handle member 302. The trigger member 304 has not been described for the sake of the brevity. Further, the trigger member 304 is capable of triggering actuation of shifting of gears of the automatic transmission automobile. Furthermore, the actuating mechanism 306 is disposed in the cavity portion 312 of the handle member 302. The actuating mechanism 306 is operatively coupled to the trigger member 304 for actuating the shifting of gears of the automatic transmission automobile.

According to the present embodiment of the present disclosure the actuating mechanism 306 includes a hollow guider 316, a rod 318 and a pair of biasing arrangements, such as a first biasing arrangement 320a and a second biasing arrangement 320b (collectively referred to as biasing arrangements 320). The hollow guider 316, the rod 318 and the biasing arrangements 320 of the actuating mechanism 306 for the automobile gear shifter kit 300 enables the shifting of gears, when an operator of the automatic transmission automobile grips the handle member 302 and triggers the trigger member 304. More particularly, the hollow guider 316 is disposed in the cavity portion 312 of the handle member 302. Further, the rod 318 is received within the hollow guider 316. Furthermore, the biasing arrangements 320 is capable of being triggered by the trigger member 304 for actuating the rod 318 to slide reciprocatingly within the hollow guider 316 for actuating the shifting of gears of the automatic transmission automobile. Specifically, the first biasing arrangement 320a is configured in relation to the trigger member 304 and an upper end portion of the rod 318, and the second biasing arrangement 320b is configured in relation to a lower portion of the rod 318.

The first biasing arrangement 320a includes a spring 322, and a plunger 324 coupled to the spring 322. Similarly, the second biasing arrangement 320b includes a spring 326 and a plunger 328. The spring 326 and the plunger 328 put an upward force on the rod 318. Further, when the trigger is depressed, the plunger 324 depresses the spring 322 allowing the rod 318 to move upward in the hollow guider 316, thereby releasing a locking mechanism (not shown) of the automatic transmission automobile for the shifting of gears.

Further, similar to the automobile gear shifter kit 100, the automobile gear shifter kit 300 also includes a plurality of switches 330 and a joystick switch 332. The plurality of switches 330 and the joystick switch 332 are coupled to electric wires 334 and an electric wire 336, respectively. The electric wires 334 and the electric wire 336 are capable of passing through a through hole 338 and hosed in a wire harness 340. The plurality of switches 330 and the joystick switch 332 are capable of performing auxiliary functions similar to the auxiliary functions performed by the plurality of switches 116 and the joystick switch 118. Therefore, the plurality of switches 330 and the joystick switch 332 have not been described for the sake of brevity of description.

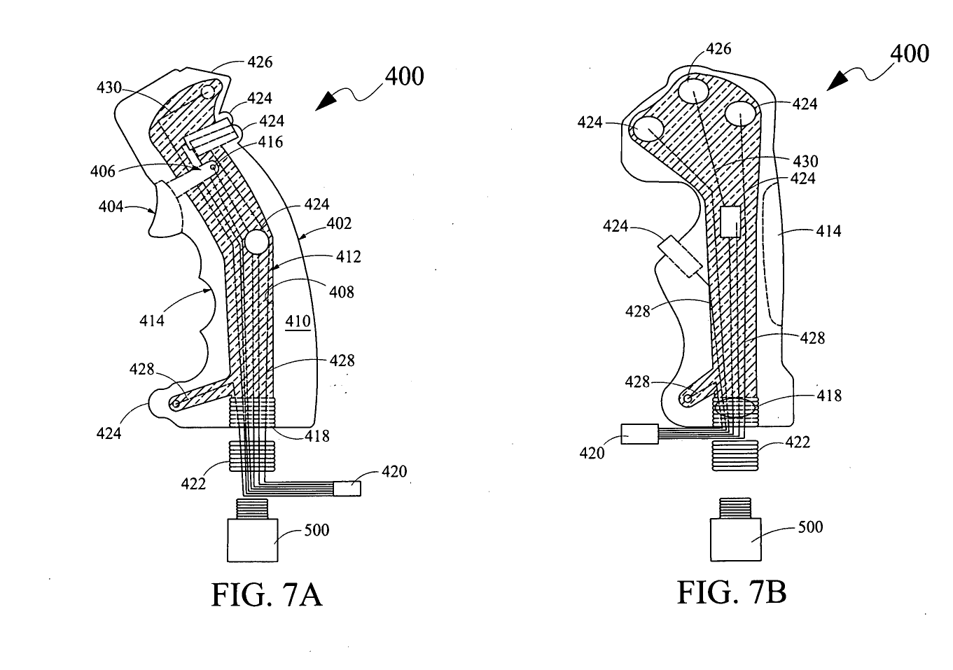

Referring now to FIG. 7A and FIG. 7b, wherein FIG. 7A illustrates a side view of an exposed automobile gear shifter kit, such as an automobile gear shifter kit 400 for an automobile with manual transmission (not shown, and hereinafter after referred to as manual transmission automobile), and FIG. 7B illustrates a front view of the exposed automobile gear shifter kit, such as the automobile gear shifter kit 400, in accordance with another embodiment of the present disclosure. The automobile gear shifter kit 400 may be configured to the manual transmission automobile for triggering actuation of an operation of pre-determined auxiliary function of the manual transmission automobile. The automobile gear shifter kit 400 includes a handle member 402, a trigger member 404, and an actuating mechanism 406.

The handle member 402 is similar to the handle member 102 as described above. Further, similar to the handle member 102, the handle member 402 includes an inner surface 408 and an outer surface 410. The inner surface 408 is configured to define a cavity portion 412 (shown as shaded region). The outer surface 410 is configured to provide a pilot control grip 414 similar to the pilot control grip 114. The handle member 402 has not been described in details for the sake of the brevity. The trigger member 404, similar to the trigger member 104, is disposed on the outer surface 410 of the handle member 402. The trigger member 404 has not been described in details for the sake of the brevity. Further, the trigger member 404 is capable of triggering actuation of the operation of pre-determined auxiliary function of the manual transmission automobile. Furthermore, the actuating mechanism 406 is disposed in the cavity portion 412 of the handle member 402. The actuating mechanism 406 is operatively coupled to the trigger member 404 for actuating the operation of pre-determined auxiliary function of the manual transmission automobile.

According to the present embodiment of the present disclosure, the actuating mechanism 406 includes an electrical conductive wire 416 disposed within the cavity portion 412 of the handle member 402. More particularly, the electrical conductive wire 416 passes through the cavity portion 412 of the handle member 402, and extends outwardly from the cavity portion 412 through a through hole 418 configured on a lower portion of the handle member 402. The electrical conductive wire 416 is hosed using a wire harness 420, similar to the wire harness 124. Further, the electrical conductive wire 416 is coupled to the manual transmission automobile's control panel for actuating the operation of pre-determined auxiliary function of the manual transmission automobile. The operation of pre-determined auxiliary function of the manual transmission automobile may be a trans-brake, a line-lock, a nitrous oxide activation, turning on a light, stopping flow of transmission fluid, and the like. Without departing from the scope of the present disclosure, the actuating mechanism 406 including the electrical conductive wire 416 is capable of actuation of any pre-determined auxiliary function of the manual transmission automobile to which the actuating mechanism 406 is rated for. Typically, voltage/current may flow through the electrical conductive wire 416 when the trigger member 404 is pressed. Such voltage/current may flow through the electrical conductive wire 416 for the actuation of pre-determined auxiliary function of the manual transmission automobile. Further, such voltage/current may flow through the electrical conductive wire 416 for the actuation of pre-determined auxiliary function of the manual transmission automobile, until the pressed trigger member 404 is released.

The handle member 402 may be removably coupled to a gear shifter shaft 500 of the manual transmission automobile for triggering actuation of the operation of pre-determined auxiliary function. More particularly, the handle member 402 and the gear shifter shaft 500 of the manual transmission automobile may be removably coupled to each other through a shaft bushing member 422.

Further, similar to the automobile gear shifter kit 100 and the automobile gear shifter kit 300, the automobile gear shifter kit 400 also includes a plurality of switches 424 and a joystick switch 426. The plurality of switches 424 and the joystick switch 426 are coupled to electric wires 428 and an electric wire 430, respectively. Further, the electric wires 428 and the electric wire 430 are hosed using the wire harness 420. The plurality of switches 424 and the joystick switch 426 are similar to the plurality of switches 116 and the joystick switch 118 of the automobile gear shifter kit 100, and the plurality of switches 330 and the joystick switch 332 of the automobile gear shifter kit 300. The plurality of switches 424 and the joystick switch 426 are capable of performing auxiliary functions similar to the auxiliary functions performed by the plurality of switches 116 and the joystick switch 118 and the plurality of switches 330 and the joystick switch 332, Therefore the plurality of switches 424 and the joystick switch 426 have not been described in detail for the sake of brevity of description.

The present disclosure provides automobile gear shifter kits, such as the automobile gear shifter kit 100, the automobile gear shifter kit 300, and the automobile gear shifter kit 400, which offers the following advantages. The automobile gear shifter kits provide convenience to an operator while changing gears for providing transmission to an automobile with manual transmission, and an automobile with automatic transmission, herein referred to as automobile. More specifically, handle members of the automobile gear shifter kits are configured to provide pilot control grips for maneuvering the handle members in the convenient manner to perform the shifting of gears of the automobile, by the operator. Particularly, the outer surfaces of the handle members are configured to provide the pilot control grips similar to flight control grips configured on pilot handle gear shifters of aircrafts. Further, the handle members are molded from resin material, thereby enhancing adaptability of the automobile gear shifter kit 100 in terms of convenience and ergonomic gripping. Further, the automobile gear shifter kits preclude inconvenience to an operator in locating a particular switch for performing a particular function in the automobile. Plurality of switches and joystick switches are capable of being operated to perform pre-determined auxiliary functions, such as a trans-brake, a line-lock, a nitrous oxide activation, turning on a light, stopping flow of transmission fluid and the like, thereby precluding the operator to feel inconvenience in locating a particular switch from various locations of the automobile for performing a particular function. Moreover, as described above in conjunction with FIGS. 1 to 7A, the automobile gear shifter kits, such as the automobile gear shifter kit 100, the automobile gear shifter kit 300, and the automobile gear shifter kit 400 are adaptable to varieties of gear shifter shaft of the automatic transmission automobile and the manual transmission automobile.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An automobile gear shifter kit comprising:
a handle member capable of being removably coupled to a gear shifter shaft of an automobile, the handle member comprising an inner surface and an outer surface, wherein the inner surface is configured to define a cavity portion and the outer surface is configured to provide a pilot control grip for maneuvering the handle member;
a trigger member disposed on the outer surface of the handle member, the trigger member capable of triggering actuation of at least one of shifting of gears of the automobile and an operation of pre-determined auxiliary function of the automobile; and
an actuating mechanism disposed in the cavity portion, the actuating mechanism operatively coupled to the trigger member and capable of being triggered by the trigger member for actuating the at least one of the shifting of gears of the automobile and the operation of pre-determined auxiliary function.

2. The automobile gear shifter kit of claim 1, wherein the actuating mechanism comprises
a trigger shaft operatively coupled to the trigger member and extending outwardly from the cavity portion of the handle member,
a hollow shaft coupled to the handle member for removably coupling the handle member to the gear shifter shaft of the automobile, the hollow shaft capable of receiving the trigger shaft extending from the cavity portion of the handle member, the hollow shaft comprising a slot configured thereon, and
a shifter actuating shaft coupled to the trigger shaft via a clamp member passing through the slot, the shifter actuating shaft capable of actuating the shifting of gears upon triggering of the trigger member.

3. The automobile gear shifter kit of claim 2, wherein the hollow shaft further comprises a pair of screw holes for removably coupling the handle member to the gear shifter shaft of the automobile.

4. The automobile gear shifter kit of claim 1, wherein the actuating mechanism comprises
a hollow guider disposed in the cavity portion of the handle member,
a rod received within the hollow guider, and
a pair of biasing arrangements capable of being triggered by the trigger member for actuating the rod to slide reciprocatingly within the hollow guider for actuating the shifting of gears.

5. The automobile gear shifter kit of claim 1, wherein the actuating mechanism comprises an electrical conductive wire disposed within the cavity portion of the handle member for triggering actuation of the operation of pre-determined auxiliary function of the automobile.

6. The automobile gear shifter kit of claim 5 further comprising a shaft bushing member for removably coupling the handle member to the gear shifter shaft of the automobile.

7. The automobile gear shifter kit of claim 1 further comprising a plurality of switches disposed on the outer surface of the handle member, each switch of the plurality of switches capable of being operated to perform a pre-determined auxiliary function of the automobile.

8. The automobile gear shifter kit of claim 1 further comprising a joystick switch disposed on the outer surface of the handle member, the joystick switch capable of being operated to perform a plurality of pre-determined auxiliary functions of the automobile.

9. The automobile gear shifter kit of claim 1, wherein the handle member is molded from a resin material.

10. An automobile gear shifter kit for an automobile with automatic transmission, the automobile gear shifter kit comprising:
a handle member capable of being removably coupled to a gear shifter shaft of the automobile with automatic transmission, the handle member comprising an inner surface and an outer surface, wherein the inner surface is configured to define a cavity portion and the outer surface is configured to provide a pilot control grip for maneuvering the handle member;
a trigger member disposed on the outer surface of the handle member, the trigger member capable of triggering actuation of shifting of gears of the automobile with automatic transmission; and
an actuating mechanism, the actuating mechanism comprising
a trigger shaft operatively coupled to the trigger member and extending outwardly from the cavity portion of the handle member,
a hollow shaft coupled to the handle member for removably coupling the handle member to the gear shifter shaft of the automobile with automatic transmission, the hollow shaft capable of receiving the trigger shaft extending from the cavity portion of the handle member, the hollow shaft comprising a slot configured thereon, and
a shifter actuating shaft coupled to the trigger shaft via a clamp member passing through the slot, the shifter actuating shaft capable of actuating the shifting of gears upon triggering of the trigger member.

11. The automobile gear shifter kit of claim 10, wherein the hollow shaft further comprises a pair of screw holes for removably coupling the handle member to the gear shifter shaft of the automobile with automatic transmission.

12. The automobile gear shifter kit of claim 10 further comprising a plurality of switches disposed on the outer surface of the handle member, each switch of the plurality of switches capable of being operated to perform a pre-determined auxiliary function of the automobile with automatic transmission.

13. The automobile gear shifter kit of claim 10 further comprising a joystick switch disposed on the outer surface of the handle member, the joystick switch capable of being operated to perform a plurality of pre-determined auxiliary functions of the automobile with automatic transmission.

14. An automobile gear shifter kit for an automobile with automatic transmission, the automobile gear shifter kit comprising:
a handle member capable of being removably coupled to a gear shifter shaft of the automobile with automatic transmission, the handle member comprising an inner surface and an outer surface, wherein the inner surface is configured to define a cavity portion and the outer surface is configured to provide a pilot control grip for maneuvering the handle member;
a trigger member disposed on the outer surface of the handle member, the trigger member capable of triggering actuation of shifting of gears of the automobile with automatic transmission; and
an actuating mechanism, the actuating mechanism comprising,
a hollow guider disposed in the cavity portion of the handle member,
a rod received within the hollow guider, and
a pair of biasing arrangements capable of being triggered by the trigger member for actuating the rod to slide reciprocatingly within the hollow guider for actuating the shifting of gears.

15. The automobile gear shifter kit of claim 14 further comprising a plurality of switches disposed on the outer surface of the handle member, each switch of the plurality of switches capable of being operated to perform a pre-determined auxiliary function of the automobile with automatic transmission.

16. The automobile gear shifter kit of claim 14 further comprising a joystick switch disposed on the outer surface of the handle member, the joystick switch capable of being operated to perform a plurality of pre-determined auxiliary functions of the automobile with automatic transmission.

17. An automobile gear shifter kit for an automobile with manual transmission, the automobile gear shifter kit comprising:
a handle member capable of being removably coupled to a gear shifter shaft of the automobile with manual transmission, the handle member comprising an inner surface and an outer surface, wherein the inner surface is configured to define a cavity portion and the outer surface is configured to provide a pilot control grip for maneuvering the handle member;
a trigger member disposed on the outer surface of the handle member, the trigger member capable of triggering actuation of an operation of pre-determined auxiliary function of the automobile with manual transmission; and
an actuating mechanism, the actuating mechanism comprising an electrical conductive wire disposed within the cavity portion of the handle member for triggering actuation of the operation of pre-determined auxiliary function of the automobile with manual transmission.

18. The automobile gear shifter kit of claim 17 further comprising a shaft bushing member for removably coupling the handle member to the gear shifter shaft of the automobile with manual transmission.

19. The automobile gear shifter kit of claim 17 further comprising a plurality of switches disposed on the outer surface of the handle member, each switch of the plurality of switches capable of being operated to perform a pre-determined auxiliary function of the automobile with manual transmission.

20. The automobile gear shifter kit of claim 17 further comprising a joystick switch disposed on the outer surface of the handle member, the joystick switch capable of being operated to perform a plurality of pre-determined auxiliary functions of the automobile with manual transmission.
